(19) United States
(12) Patent Application Publication
(10) Pub. No.: US 2015/0101063 A1
(43) Pub. Date: Apr. 9, 2015

(54) INFORMATION PROCESSING APPARATUS AND METHOD, AND NON-TRANSITORY COMPUTER READABLE MEDIUM

(71) Applicant: FUJI XEROX CO., LTD., Tokyo (JP)

(72) Inventor: Noriyuki SHIMOKAWA, Kanagawa (JP)

(73) Assignee: FUJI XEROX CO., LTD., Tokyo (JP)

(21) Appl. No.: 14/297,055

(22) Filed: Jun. 5, 2014

(30) Foreign Application Priority Data
Oct. 4, 2013 (JP) 2013-208971

(51) Int. Cl. G06F 21/62

(52) U.S. Cl. CPC G06F 21/6218
USPC 726/28

(57) ABSTRACT

An information processing apparatus includes the following elements. A checking unit checks whether or not a position of a user is outside the premises of an organization to which the user belongs. A first obtaining unit obtains, if it is checked that the position of the user is outside the premises, information specifying documents which are stored in a document management device disposed on the premises and which are allowed to be used by the user, instead of obtaining the content of the documents. A presenting unit presents a list of the documents. A selector selects a document from among the documents in the list in accordance with an operation of the user. A second obtaining unit obtains the content of the selected document from the document management device. A providing unit provides the obtained content of the document to an output device which outputs the content of the document.

### CROSS-REFERENCE TO RELATED APPLICATIONS

This application is based on and claims priority under 35 USC 119 from Japanese Patent Application No. 2013-208971 filed Oct. 4, 2013.

### BACKGROUND

### Technical Field

The present invention relates to an information processing apparatus and method, and a non-transitory computer readable medium.

### SUMMARY

According to an aspect of the invention, there is provided an information processing apparatus including: a checking unit that checks whether or not a position of a user is outside the premises of an organization to which the user belongs; a first obtaining unit that obtains, if it is checked by the checking unit that the position of the user is outside the premises, information that specifies documents which are stored in a document management device disposed on the premises and which are allowed to be used by the user, instead of obtaining the content of the documents; a presenting unit that presents a list of the documents to the user; a selector that selects a document from among the documents in the list in accordance with a selecting operation performed by the user; a second obtaining unit that obtains the content of the document selected by the selector from the document management device disposed on the premises; and a providing unit that provides the content of the document obtained by the second obtaining unit to an output device which outputs the content of the document.

### BRIEF DESCRIPTION OF THE DRAWINGS

An exemplary embodiment of the present invention will be described in detail based on the following figures, wherein:

FIG. 1 is a block diagram illustrating conceptual modules of an example of the configuration of an exemplary embodiment;

FIG. 2 is a block diagram illustrating an example of the system configuration that implements this exemplary embodiment;

FIGS. 3A and 3B show a flowchart of an example of processing performed in this exemplary embodiment;

FIG. 4 illustrates an example of the data structure of a document management table;

FIG. 5 illustrates an example of a tree structure of folders and documents;

FIG. 6 illustrates an example of the data structure of a temporary-synchronization information table;

FIG. 7 illustrates an example of the data structure of a tree table;

FIG. 8 illustrates an example of the data structure of a position information table;

FIGS. 9A and 9B show a flowchart of an example of processing performed in this exemplary embodiment;

FIGS. 10A and 10B show a flowchart of an example of processing performed in this exemplary embodiment; and

FIG. 11 is a block diagram illustrating an example of the hardware configuration of a computer that implements this exemplary embodiment.

### DETAILED DESCRIPTION

An exemplary embodiment of the present invention will be described below with reference to the accompanying drawings.

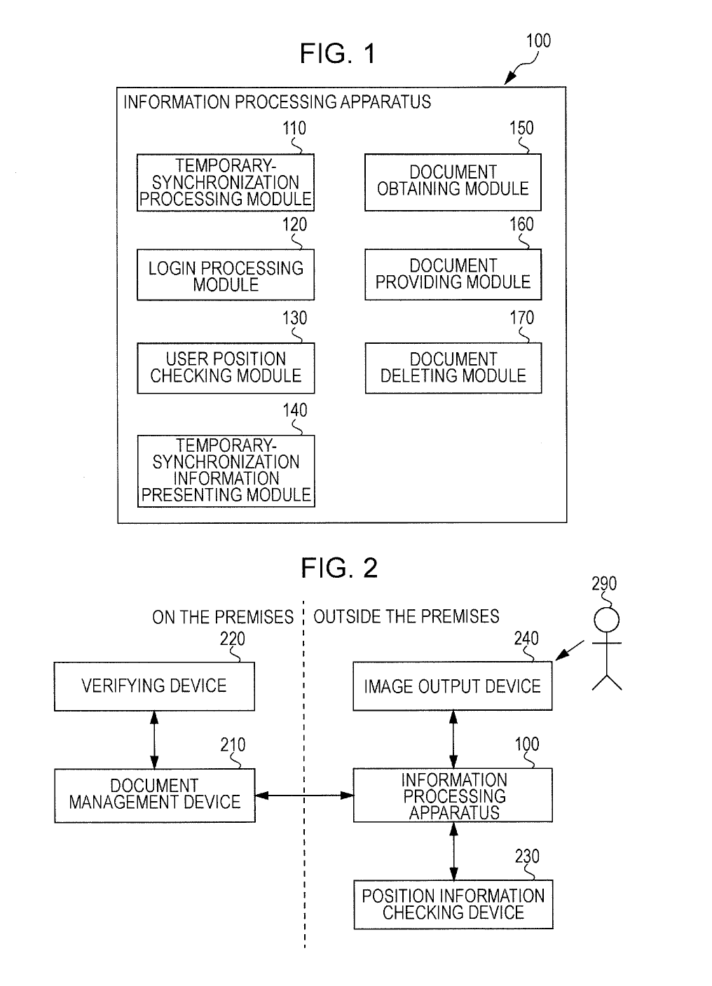

FIG. 1 is a block diagram illustrating conceptual modules of an example of the configuration of this exemplary embodiment.

Generally, modules are software (computer programs) components or hardware components that can be logically separated from one another. Accordingly, the modules of the exemplary embodiment of the invention are not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program is stored in a storage device. Modules may correspond to functions based on a one-on-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationship among data elements, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is necessary.

A system or an apparatus may be realized by connecting plural computers, hardware units, devices, etc., to one another via a communication medium, such as a network (including communication based on a one-on-one correspondence), or may be realized by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processed result is written into the storage device. Accordingly, a description of reading from the storage device before an operation or writing into the storage device after an operation may be omitted. Examples of the storage device may be a hard disk (HD), a random access memory (RAM), an external storage medium, a storage device using a communication line, a register within a central processing unit (CPU), etc.

An information processing apparatus 100 of this exemplary embodiment allows documents stored on the premises of a certain organization (for example, a company) to be output outside the premises. The information processing apparatus 100 includes, as shown in FIG. 1, a temporary-synchronization processing module 110, a login processing module 120, a user position checking module 130, a temporary-synchronization information presenting module 140, a document obtaining module 150, a document providing module 160, and a document deleting module 170. The information processing apparatus 100 is, for example, a server which implements cloud services. The meaning of “outputting a document outside the premises” includes, not only that a document is printed by using a printer or a multifunction device (an image processing apparatus including at least two functions of a scanner, a printer, a copying machine, and a fax machine), and but also that a document is displayed in a display device, such as a liquid crystal display. Hereinafter, printing of a document by using a printer will be discussed by way of example. “Documents stored on the premises” means that documents are stored in a document management device disposed on the premises. “Being on the premises” means that documents are within an intranet (for example, documents are stored in a device connected to an intranet), and, usually, by setting a firewall for the sake of security, the documents are protected from direct access to devices (for example, the above-described document management device) connected to the intranet on the premises from the outside. On the other hand, there is a case in which, for example, when giving a presentation to a client, a user may wish to print out a document by using a copying machine installed in a place near the client (for example, a copying machine installed in a corner store). In this case, it is necessary to print out a document stored on the premises by using a copying machine outside the premises in response to an instruction from the user outside the premises. It is noted that the information processing apparatus 100 is installed outside the premises (outside the intranet).

The temporary-synchronization processing module 110 communicates with the document management device disposed on the premises and generates information concerning documents that may be output outside the premises by a subject user. “Information concerning documents that may be output outside the premises” is information that can specify such documents, but does not indicate the documents themselves (the content of the documents). Information that can specify a document is at least one of or a combination of a document name (file name), a document identifier, a position of the document in a hierarchical structure, a time and a date at which the document was formed (millisecond, second, minute, hour, day, month, and year, or a combination thereof), and a document type (extension of a file). The documents themselves are stored in the document management device on the premises. That is, the documents themselves are stored in the document management device within the intranet, and are not transferred to and stored in the information processing apparatus 100 outside the premises until they are actually output outside the premises. When outputting a document outside the premises, the document obtaining module 150 obtains the document from the document management device and stores the document in the information processing apparatus 100.

In response to an operation performed by a subject user or a person other than the user (a person who specifies a document which will be output outside the premises to a user, for example, a boss of the user), the document management device specifies a document to be output outside the premises by this user. Then, the document management device generates information concerning the specified document, and sends this information to the temporary-synchronization processing module 110 of the information processing apparatus 100.

The login processing module 120 performs login processing, and more specifically, the login processing module 120 checks whether or not a user is registered in services (including functions provided by this exemplary embodiment) provided by the information processing apparatus 100. For example, the login processing module 120 may receive the input of a user ID (identification) and a password as a result of the user operating, for example, a keyboard, and may check the received user ID and password against those registered in advance. Alternatively, the login processing module 120 may read an integrated circuit (IC) card owned by the user by using an IC card reader, and may check information stored in the IC card. The login processing module 120 may utilize another technique, such as biometrics authentication using, for example, fingerprints.

The user position checking module 130 checks whether or not the position of a user is outside the premises of an organization to which the user belongs. For example, the user position checking module 130 may check the position of a user on the basis of information concerning the entrance and exit to and from the premises made by a user and detected by an entrance-and-exit detector (hereinafter such a detector will also referred to as a “flapper gate”). For example, when passing through a flapper gate, the user passes an IC card of the user over an IC card reader. Then, the entrance-and-exit detector reads the user ID stored in the IC card, and records the direction of the user (whether the user left the premises to the outside or entered the premises from the outside), a time and a date at which the user passed through the flapper gate, and information (flapper gate ID) for identifying the flapper gate through which the user passed.

The user position checking module 130 may check the position of a user on the basis of position information detected by a position detector provided within a mobile terminal device (hereinafter also referred to as a “mobile terminal”) owned by the user. The position detector may utilize position information output from a global positioning system (GPS) or position information provided by a base station used in a cellular phone network. An example of the mobile terminal device is a cellular phone (may be a smartphone).

The user position checking module 130 may check the position of a user from at least one of or a combination of information output from a schedule management device that manages schedules of the user and information output from an attendance management device that manages an attendance record of the user. In this case, the user position checking module 130 determines that the user is not on the premises when one of the following three cases is applied: (1) the position of the user is not on the premises on a certain date and the user is not supposed to be on the premises according to the schedule of the same date (the minute and the hour may be included, which will also be applied to cases (2) and (3)); (2) the position of the user is not on the premises on a certain date and the user is not supposed to be on the premises according to the attendance record of the same date; and (3) the position of the user is not on the premises on a certain date, the user is not supposed to be on the premises according to the schedule of the same date, and the user is not supposed to be on the premises according to the attendance record of the same date. If the information output from the schedule management device is used, the user position checking module 130 obtains a schedule of a subject user at a time and a date at which a document will be output, and checks whether or not the schedule shows that the user is outside the premises. If the information output from the attendance management device is used, the user position checking module 130 obtains attendance information concerning a subject user at a time and a date at which a document will be output, and checks whether or not the attendance information shows that the user is outside the premises.

Alternatively, the user position checking module 130 may check whether or not the position of the user is not on the premises and whether or not an output device is installed at a predetermined position (region). For example, items of identification information of output devices and items of position information concerning the output devices may be stored in association with each other in advance, and the item of identification information of an output device that the user will use may be obtained, and the position information concerning this output device may be obtained.

After the user position checking module 130 has checked that the position of the user is not on the premises, the temporary-synchronization information presenting module 140 presents information concerning documents that may be output outside the premises. The temporary-synchronization information presenting module 140 presents information generated by the temporary-synchronization processing module 110 to an output device used by the user. In this case, the temporary-synchronization information presenting module 140 presents information by displaying the information in a display device, such as a liquid crystal display, provided in the output device, or by outputting the information from a sound output device, such as a speaker, provided in the output device.

The document obtaining module 150 selects one of the documents presented by the temporary-synchronization information presenting module 140 in accordance with an operation performed by the user. The document obtaining module 150 detects an operation performed by the user on, for example, a keyboard, a mouse, or a touch panel.

Then, the document obtaining module 150 obtains the selected document from the document management device disposed on the premises. In order to make access from the information processing apparatus 100 outside the premises (outside the intranet) to the document management device disposed on the premises (inside the intranet), for example, the information processing apparatus 100 first sends an email describing information which specifies the selected document to the document management device. Then, the document management device analyzes the received email, obtains the document, and then sends the document to the information processing apparatus 100. As the information which specifies the selected document, an expression for searching for the selected document may be utilized.

The document obtaining module 150 may obtain a document if at least one of or a combination of the following items of information satisfies a condition for obtaining this document: (1) a maximum number of times a document is allowed to be output; (2) a time zone in which a document is allowed to be obtained; and (3) the position of a user. A determination as to whether one of or a combination of these items of information satisfies a condition set for obtaining the document may be made by the document obtaining module 150 or the document management device. If the item (1) a maximum number of times a document is allowed to be output is used as a condition, the number of times a certain document has been output is counted, and it is determined whether or not the counted number has reached the maximum number. If the item (2) a time zone in which a document is allowed to be obtained is used as a condition, it is determined whether or not a time and a date at which a document will be obtained by the document obtaining module 150 is contained within a certain time zone. If the item (3) the position of a user is used as a condition, it is determined, not only whether or not a user is outside the premises, but also whether or not the user is at a predetermined position (region).

Documents that may be output outside the premises may be classified as some levels according to the position of a user. That is, the document obtaining module 150 may obtain documents only that satisfy conditions according to the position of a user. For example, documents may be classified as some levels according to the confidentiality. In this case, as the user is positioned farther away from the premises, it may make it more difficult for the document obtaining module 150 to obtain a document of a higher confidentiality. Additionally, the levels of confidentiality may be associated with regions, such as cities and prefectures, and the document obtaining module 150 may obtain a document of a confidentiality level according to the region in which the user is positioned.

The document providing module 160 provides a document obtained by the document obtaining module 150 to an output device that outputs this document. Then, the output device outputs the document. The output device then sends notification indicating that the document has been output to the document deleting module 170 of the information processing apparatus 100.

Upon receiving this notification from the output device, the document deleting module 170 deletes the document from the information processing apparatus 100. This processing is performed in order to reduce the time for which the document is stored in the information processing apparatus 100.

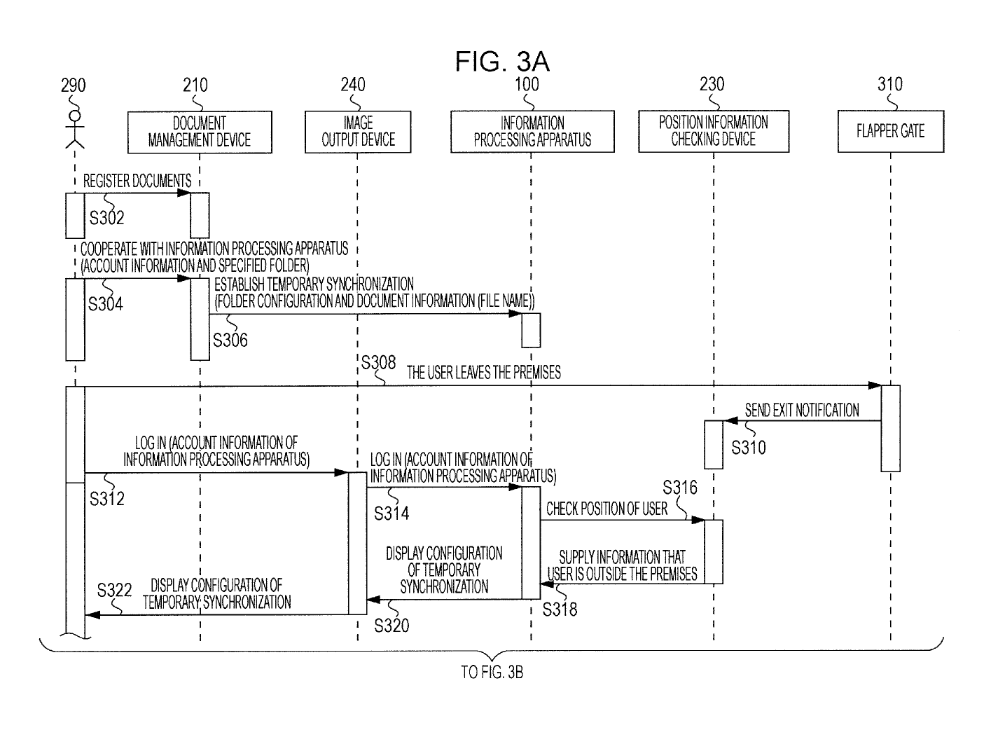

FIG. 2 is a block diagram illustrating an example of the system configuration that implements this exemplary embodiment. A document management device 210 and a verifying device 220 are installed on the premises of a certain organization and are thus within an intranet of this organization. The information processing apparatus 100, a position information checking device 230, an image output device 240 are installed outside the premises and are thus outside the intranet (for example, these devices are connected to the Internet).

The document management device 210 is a device that manages documents, and serves as an on-premises server installed on the premises.

The verifying device 220 is a device that analyzes and verifies information obtained from the information processing apparatus 100. For example, the verifying device 220 verifies a user ID or a device certificate (digital certificate) of the image output device 240. That is, the verifying device 220 verifies that a user 290 is a member of a certain organization (for example, a company) and that the image output device 240 is a reliable device.

The information processing apparatus 100 is a cloud server (outside an intranet) and serves as a device that stores documents therein (cloud storage).

The image output device 240 is, for example, a printer or a multifunction device.

The position information checking device 230 is a device that stores information indicating whether or not the user 290 is outside the premises of this organization.

The user 290 performs an operation for causing the image output device 240 to output a document. The information processing apparatus 100 checks by using the position information checking device 230 that the user 290 is located at a position outside the premises, extracts a subject document from the document management device 210, and sends the document to the image output device 240. Thereafter, the information processing apparatus 100 deletes the document.

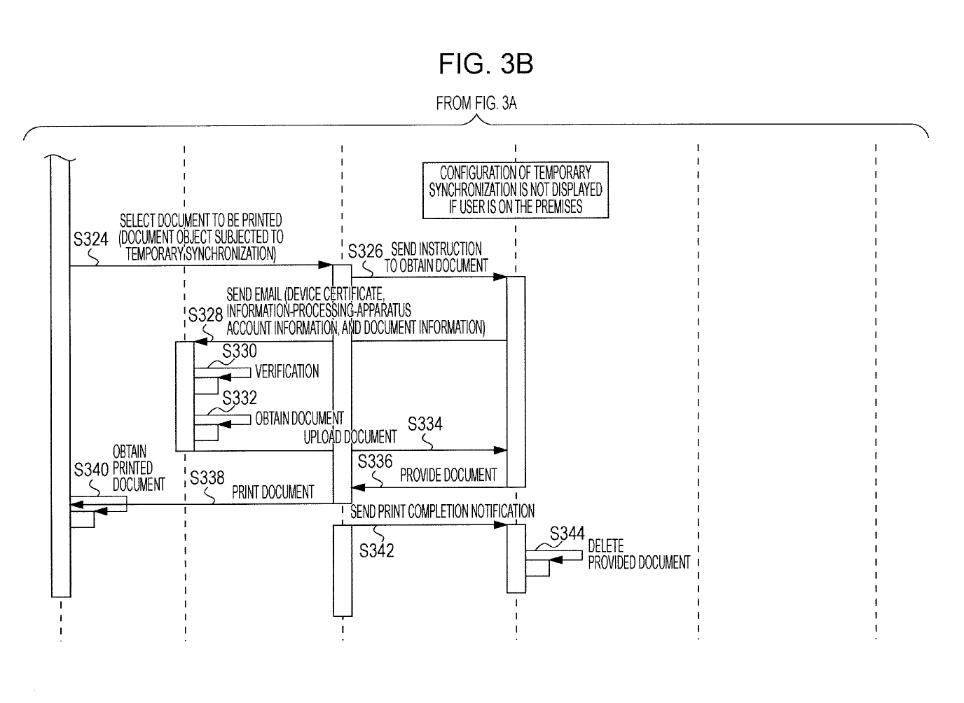

FIGS. 3A and 3B show a flowchart of an example of processing performed in this exemplary embodiment. A description will be given of an example of processing performed among the user 290, the document management device 210, the image output device 240, the information processing apparatus 100, the position information checking device 230, and a flapper gate 310.

In step S302, the document management device 210 registers documents in accordance with an operation performed by the user 290. Documents registered in step S302 include a document to be output by the image output device 240.

In steps S304 and S306, the document management device 210 executes processing for establishing temporary synchronization with the information processing apparatus 100 (pre-operation). Temporary synchronization refers to generating of the above-described information concerning documents that may be output outside the premises and storing of the generated information in the information processing apparatus 100. That is, synchronization between the document management device 210 and the information processing apparatus 100 is established in order to output a document indicated by the above-described information by using the image output device 240 outside the premises. In this case, the documents themselves (the content of the documents) are not subjected to temporary synchronization, but only information which specifies the documents is subjected to temporary synchronization. Accordingly, at this time point, the documents themselves managed by the document management device 210 are not stored in the information processing apparatus 100, and, instead, a tree structure of folders and files is subjected to temporary synchronization. The content of the information subjected to temporary synchronization is sent from the document management device 210 to the information processing apparatus 100 at regular intervals (in this case, the interval may be set as desired).

In step S304, the document management device 210 cooperates with the information processing apparatus 100 in accordance with an operation performed by the user 290. More specifically, the document management device 210 shares account information concerning the user 290 and a folder specified by the user 290 with the information processing apparatus 100. Specifying of a folder refers to specifying a document group to be subjected to temporary synchronization.

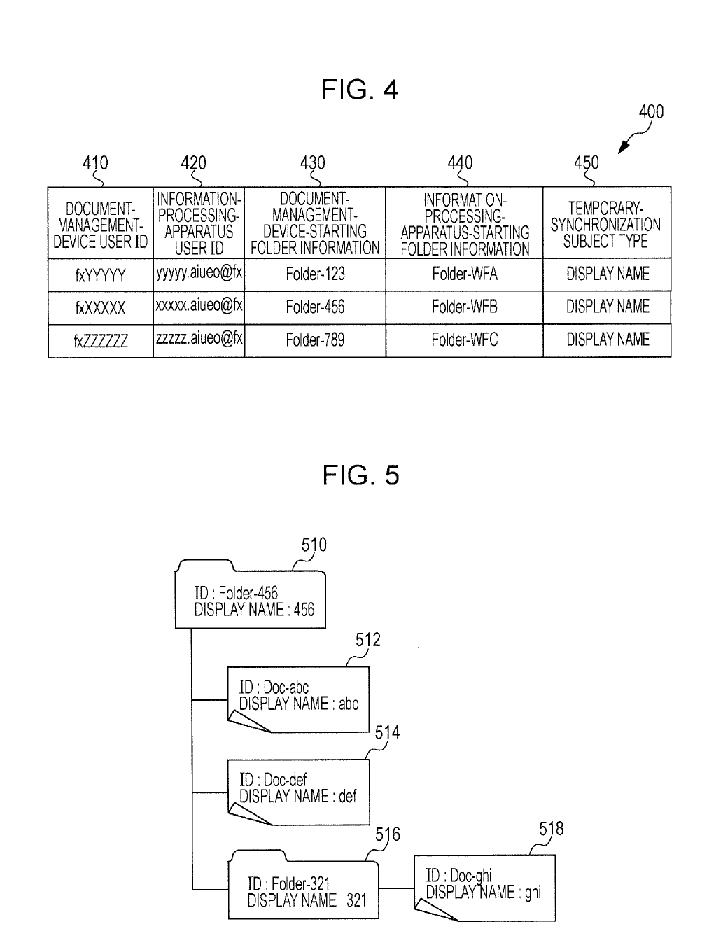

The document management device 210 generates, for example, a document management table 400. FIG. 4 illustrates an example of the data structure of the document management table 400. The document management table 400 has a document-management-device user ID field 410, an information-processing-apparatus user ID field 420, a document-management-device-starting folder information field 430, an information-processing-apparatus-starting folder information field 440, and a temporary-synchronization subject type field 450. In the document-management-device user ID field 410, information for uniquely identifying a user of the document management device 210 (document management device user ID) in this exemplary embodiment is stored. In the information-processing-apparatus user ID field 420, information for uniquely identifying a user of the information processing apparatus 100 (information processing apparatus user ID) in this exemplary embodiment is stored. That is, the document management device user ID indicated in the document-management-device user ID field 410 and the information-processing-apparatus user ID indicated in the information-processing-apparatus user ID field 420 are provided to the same user. In the document-management-device-starting folder information field 430, folder information concerning a folder which serves as a starting point of temporary synchronization in the document management device 210 is stored. Documents and folders under the folder indicated by this folder information are subjected to temporary synchronization. In the information-processing-apparatus-starting folder information field 440, folder information concerning a folder which serves as a starting point of temporary synchronization in the information processing apparatus 100 is stored. The folder indicated by this folder information is a folder corresponding to the folder, which serves as the starting point of temporary synchronization, indicated in the document-management-device-starting folder information field 430. In the temporary-synchronization subject type field 450, the type of information to be subjected to temporary synchronization is stored. As the type of information, for example, a display name (a document name or a folder name) is stored.

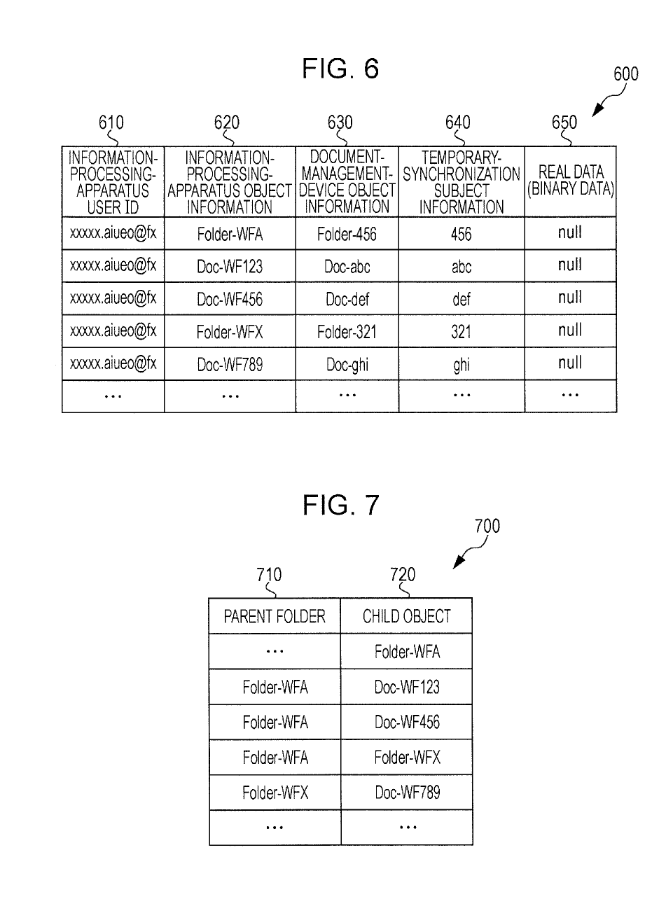

The configuration of a folder (object ID: Folder-456) to be subjected to temporary synchronization specified by the user 290 having the document management device user ID “fxXXXXX” is shown in FIG. 5 by way of example. FIG. 5 illustrates an example of a tree structure of folders and documents. In this tree structure, a folder 510 includes documents 512 and 514 and a folder 516. The folder 516 includes a document 518. The object ID of the folder 510 is Folder-456, and the display name of the folder 510 is 456. The object ID of the document 512 is Doc-abc, and the display name of the document 512 is abc. The object ID of the document 514 is Doc-def, and the display name of the document 514 is def. The object ID of the folder 516 is Folder-321, and the display name of the folder 516 is 321. The object ID of the document 518 is Doc-ghi, and the display name of the document 518 is ghi.

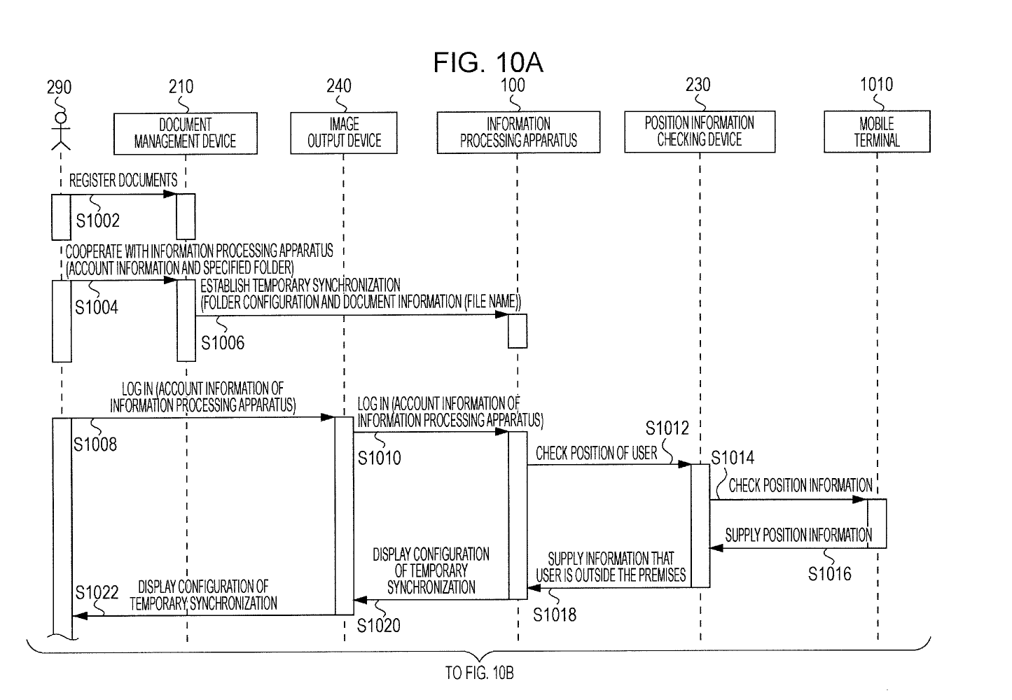

In step S306, temporary synchronization is performed between the document management device 210 and the information processing apparatus 100. That is, the document management device 210 supplies a folder configuration and document information (file names) to the information processing apparatus 100, and the temporary-synchronization processing module 110 of the information processing apparatus 100 generates information concerning documents that the user 290 may output in a place outside the premises. Details of step S306 will be discussed later with reference to FIGS. 9A and 9B.

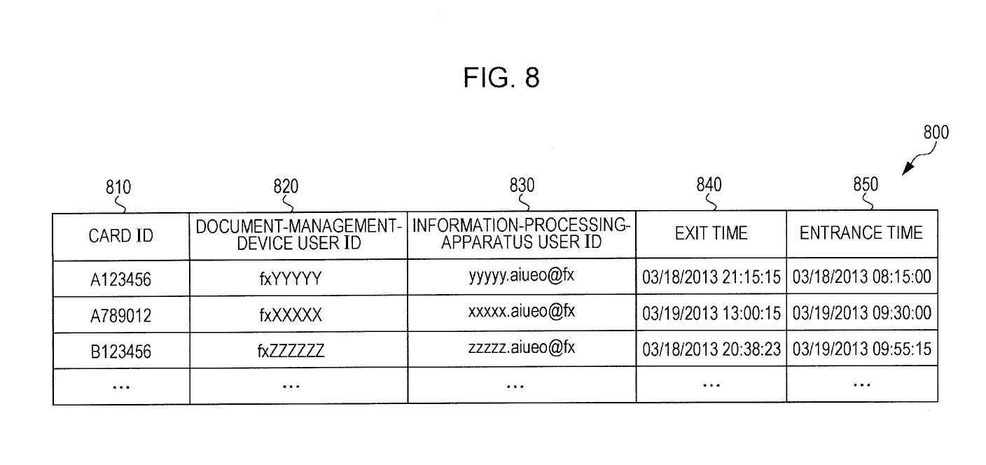

The temporary-synchronization processing module 110 of the information processing apparatus 100 generates, for example, a temporary-synchronization information table 600 and a tree table 700. FIG. 6 illustrates an example of the data structure of the temporary-synchronization information table 600. The temporary-synchronization information table 600 has an information-processing-apparatus user ID field 610, an information-processing-apparatus object information field 620, a document-management-device object information field 630, a temporary-synchronization subject information field 640, and a real data (binary data) field 650. In the information-processing-apparatus user ID field 610, an information-processing-apparatus user ID is stored. The information-processing-apparatus user ID field 610 corresponds to the information-processing-apparatus user ID field 420 of the document management table 400. In the information-processing-apparatus object information field 620, information-processing-apparatus object information is stored. The information-processing-apparatus object information field 620 corresponds to the information-processing-apparatus-starting folder information field 440 of the document management table 400. In the document-management-device object information field 630, document-management-device object information is stored. The document-management-device object information field 630 corresponds to the document-management-device-starting folder information field 430 of the document management table 400. In the temporary-synchronization subject information field 640, temporary-synchronization subject information is stored. In the example shown in FIG. 6, the display name of a folder or a document within the document-management-device object information field 630 is indicated in the temporary-synchronization subject information field 640. In the real data (binary data) field 650, real data (binary data) is stored. Until a document itself (the content of the document) is subjected to synchronization (the document is obtained in step S334), “null (empty)” is indicated in the real data (binary data) field 650, and when a document itself (the content of the document) is subjected to synchronization, the document itself (real data) is written into the real data field 650.

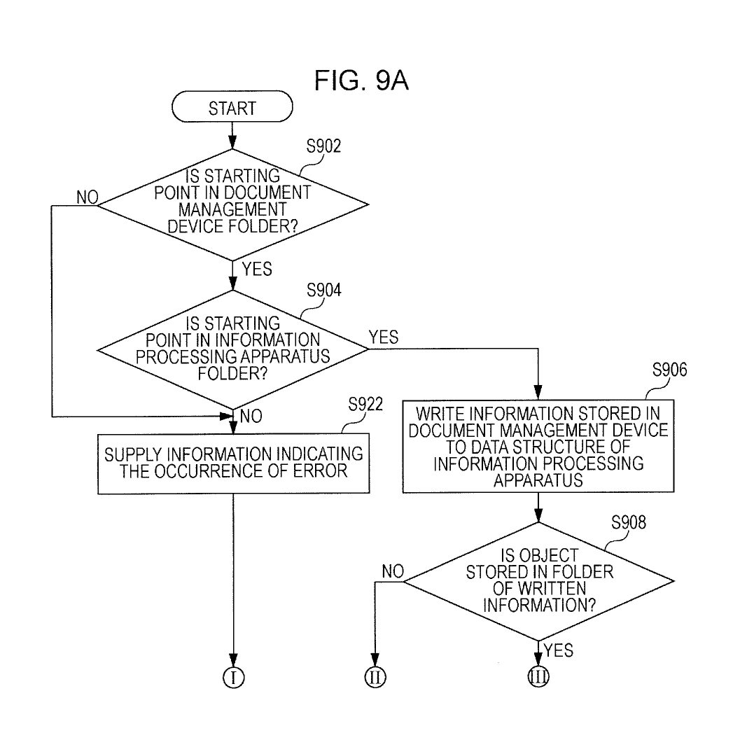

FIG. 7 illustrates an example of the data structure of the tree table 700. The tree table 700 has a parent folder field 710 and a child object field 720. In the parent folder field 710, parent folders are stored. In the child object field 720, child objects included in a parent folder in the parent folder field 710 are stored. As both of the parent folder and the child object in the parent folder field 710 and the child object field 720, the object IDs in the information-processing-apparatus object information field 620 of the temporary-synchronization information table 600 are used. The example of the data structure shown in FIG. 7 corresponds to the tree structure shown in FIG. 5.

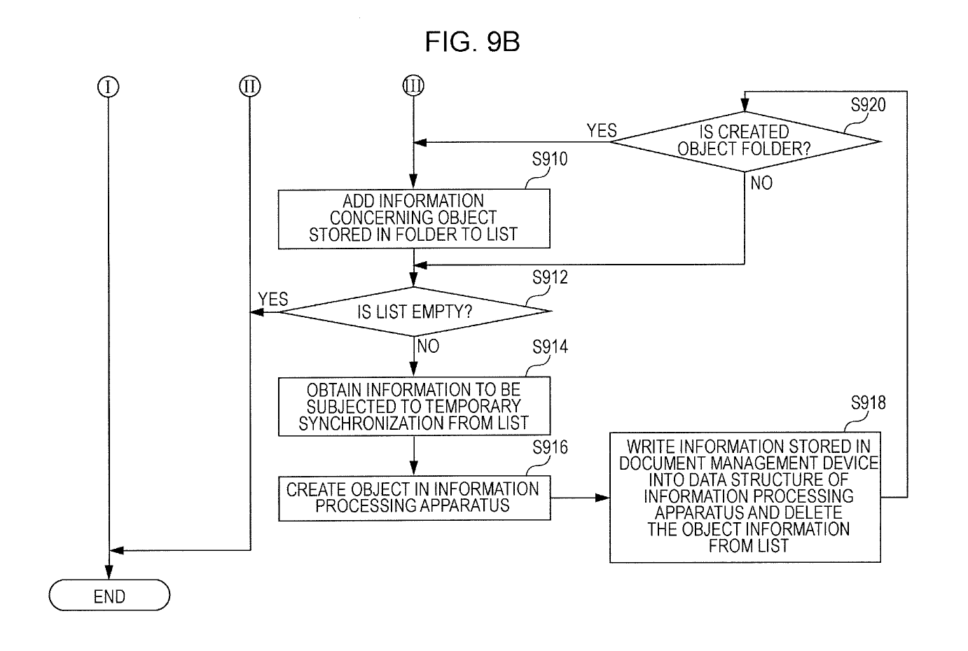

In step S308, the user 290 leaves the premises. The flapper gate 310 detects that the user 290 has left the premises. When leaving the premises, the user 290 passes the IC card over the flapper gate 310. The flapper gate 310 generates, for example, a position information table 800. FIG. 8 illustrates an example of the data structure of the position information table 800. The position information table 800 has a card ID field 810, a document-management-device user ID field 820, an information-processing-apparatus user ID field 830, an exit time field 840, and an entrance time field 850. In the card ID field 810, information for uniquely identifying the IC card passed over the flapper gate 310 (card ID) in this exemplary embodiment is stored. In the document-management-device user ID field 820, the user ID used in the document management device 210 is stored. In the information-processing-apparatus user ID field 830, the user ID used in the information processing apparatus 100 is stored. In the exit time field 840, a time and a date at which the user 290 left the premises is stored. In the entrance time field 850, a time and a date at which the user 290 entered the premises is stored. From the relationships between information in the exit time field 840 and information in the entrance time field 850 of the position information table 800 shown in FIG. 8, the following facts are found:

fxYYYYY left the premises on March 18 and has not entered the premises since then;

fxXXXXX entered the premises in the morning of March 19 and then left the premises in the afternoon of the same day, and is currently outside the premises; and

fxZZZZZ entered the premises in the morning of March 19, and remains on the premises.

In step S310, the flapper gate 310 sends an exit notification indicating that the user 290 has left the premises to the position information checking device 230.

In step S312, the user 290 logs in the image output device 240 outside the premises. In this case, the user 290 logs in by inputting account information (a user ID and a password) of the information processing apparatus 100 or by conducting authentication using an IC card.

In step S314, the image output device 240 logs in the information processing apparatus 100. That is, the image output device 240 passes the account information of the information processing apparatus 100 obtained in step S312 to the information processing apparatus 100. The login processing module 120 of the information processing apparatus 100 performs login processing.

In step S316, the user position checking module 130 of the information processing apparatus 100 causes the position information checking device 230 to check the position of the user 290.

In step S318, the position information checking device 230 informs the user position checking module 130 of the information processing apparatus 100 that the position of the user 290 is outside the premises.

In step S320, the temporary-synchronization information presenting module 140 of the information processing apparatus 100 instructs a display device provided in the image output device 240 to display a configuration of temporary synchronization (information concerning documents that may be output outside the premises by the user 290). If the position information checking device 230 informs the user position checking module 130 in step S318 that the position of the user 290 is on the premises, a configuration of temporary synchronization is not displayed in step S320.

In step S322, the image output device 240 displays a configuration of temporary synchronization for the user 290.

In step S324, the user 290 selects a document to be printed by the image output device 240. A document to be selected is a document object subjected to temporary synchronization.

In step S326, the image output device 240 instructs the information processing apparatus 100 to obtain the document selected in step S324.

In step S328, the document obtaining module 150 of the information processing apparatus 100 sends an email to the document management device 210. The email contains, for example, a device certificate of the document management device 210, account information of the user 290 used in the information processing apparatus 100, and information concerning the selected document. The format of these items of information may be an XML (eXtensible Markup Language) format, and a document including these items of information may be attached to the email.

In step S330, the document management device 210 causes the verifying device 220 to verify the device certificate of the image output device 240 and the account information of the user 290.

In step S332, after the verification in step S330 has succeeded, the document management device 210 obtains a document. In this case, the document management device 210 may obtain a document stored in the document management device 210 or a document stored in another document management device within the intranet.

In step S334, the document management device 210 uploads the document selected in step S324 to the document obtaining module 150 of the information processing apparatus 100. When uploading the document, the document management device 210 may perform conversion processing, such as encryption of the document.

In step S336, the document providing module 160 of the information processing apparatus 100 provides the document to the image output device 240. If the document has been subjected to conversion processing, such as encryption, the document providing module 160 performs decryption processing.

In step S338, the image output device 240 prints the document provided in step S336.

In step S340, the user 290 obtains the document printed by the image output device 240.

In step S342, the image output device 240 sends a print completion notification to the information processing apparatus 100.

In step S344, the document deleting module 170 of the information processing apparatus 100 deletes the document (the content of the document) provided to the image output device 240. In this case, the content of information subjected to temporary synchronization is not deleted.

FIGS. 9A and 9B show a flowchart of an example of processing (temporary synchronization processing) performed in this exemplary embodiment. The flowchart of FIGS. 9A and 9B indicates details of step S306 of the flowchart of FIG. 3A.

In step S902, it is determined whether or not the starting point of temporary synchronization in the document management device 210 is a folder. If the result of step S902 is YES, the process proceeds to step S904. If the result of step S902 is NO, the process proceeds to step S922.

In step S904, it is determined whether or not the starting point of temporary synchronization in the information processing apparatus 100 is a folder. If the result of step S904 is YES, the process proceeds to step S906. If the result of step S904 is NO, the process proceeds to step S922.

In step S906, information stored in the document management device 210 is written into the data structure of the information processing apparatus 100.

In step S908, it is determined whether an object (a document or a folder) is stored in a folder of the written information. If the result of step S908 is YES, the process proceeds to step S910. If the result of step S908 is NO, the processing is terminated.

In step S910, information concerning the object stored in the folder is added to a list.

In step S912, it is determined whether or not the list is empty. If the list is empty, the processing is terminated. If the list is not empty, the process proceeds to step S914.

In step S914, information to be subjected to temporary synchronization is obtained from the list.

In step S916, an object is created in the information processing apparatus 100 by using the information obtained in step S914.

In step S918, the information stored in the document management device 210 is written into the data structure of the information processing apparatus 100, and the object information is deleted from the list.

In step S920, it is determined whether or not the created object is a folder. If the result of step S920 is YES, the process returns to step S910. If the result of step S920 is NO, the process returns to step S912.

In step S922, information indicating the occurrence of an error is supplied to the user 290.

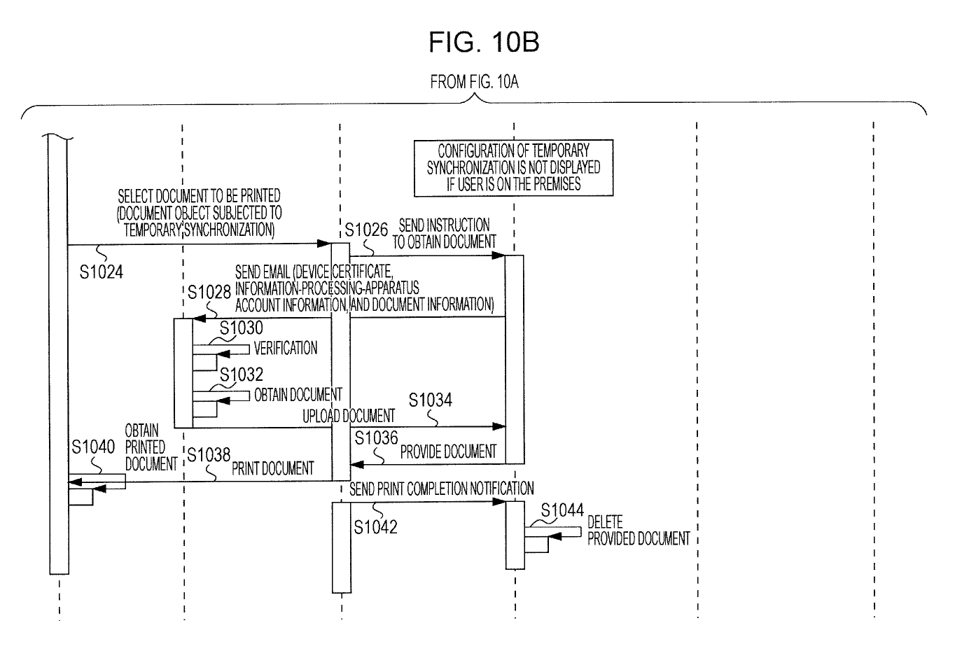

FIGS. 10A and 10B show a flowchart of an example of processing performed in this exemplary embodiment. A description will be given of an example of processing performed among the user 290, the document management device 210, the image output device 240, the information processing apparatus 100, the position information checking device 230, and a mobile terminal 1010. In FIGS. 10A and 10B, processing equivalent to the processing shown in FIGS. 3A and 3B is performed, except that the mobile terminal 1010 owned by the user 290 is used instead of the flapper gate 310.

In step S1002, the document management device 210 registers documents in accordance with an operation performed by the user 290. Documents registered in step S1002 include a document to be output by the image output device 240.

In steps S1004 and S1006, the document management device 210 executes processing for establishing temporary synchronization with the information processing apparatus 100 (pre-operation). Temporary synchronization refers to generating of the above-described information concerning documents that may be output outside the premises and storing of the generated information in the information processing apparatus 100. That is, synchronization between the document management device 210 and the information processing apparatus 100 is established in order to output a document indicated by the above-described information by using the image output device 240 outside the premises. In this case, the documents themselves (the content of the documents) are not subjected to temporary synchronization, but only information which specifies the documents is subjected to temporary synchronization. Accordingly, at this time point, the documents themselves managed by the document management device 210 are not stored in the information processing apparatus 100, and, instead, a tree structure of folders and files is subjected to temporary synchronization. The content of the information subjected to temporary synchronization is sent from the document management device 210 to the information processing apparatus 100 at regular intervals (in this case, the interval may be set as desired).

In step S1004, the document management device 210 cooperates with the information processing apparatus 100 in accordance with an operation performed by the user 290. More specifically, the document management device 210 shares account information concerning the user 290 and a folder specified by the user 290 with the information processing apparatus 100. Specifying of a folder refers to specifying a document group to be subjected to temporary synchronization.

In step S1006, temporary synchronization is performed between the document management device 210 and the information processing apparatus 100. That is, the document management device 210 supplies a folder configuration and document information (file names) to the information processing apparatus 100, and the temporary-synchronization processing module 110 of the information processing apparatus 100 generates information concerning documents that the user 290 may output in a place outside the premises.

In step S1008, the user 290 logs in the image output device 240 which is installed outside the premises. In this case, the user 290 logs in by inputting account information (a user ID and a password) of the information processing apparatus 100 or by conducting authentication using an IC card.

In step S1010, the image output device 240 logs in the information processing apparatus 100. That is, the image output device 240 passes the account information of the information processing apparatus 100 obtained in step S1008 to the information processing apparatus 100. The login processing module 120 of the information processing apparatus 100 performs login processing.

In step S1012, the user position checking module 130 of the information processing apparatus 100 causes the position information checking device 230 to check the position of the user 290.

In step S1014, the position information checking device 230 checks the position of the user 290 by using the mobile terminal 1010 owned by the user 290. More specifically, the position information checking device 230 requests the mobile terminal 1010 to send an output of GPS of the mobile terminal 1010.

In step S1016, the mobile terminal 1010 supplies position information concerning the user 290 (mobile terminal 1010) to the position information checking device 230.

In step S1018, the position information checking device 230 informs the user position checking module 130 of the information processing apparatus 100 that the position of the user 290 is outside the premises. For example, if the position indicated by the position information concerning the user 290 (mobile terminal 1010) obtained in step S1016 is not contained in an area of the premises (an area defined by the latitude and the longitude), the position information checking device 230 determines that the user 290 is outside the premises. If the position indicated by the position information is contained in the area of the premises, the position information checking device 230 determines that the user 290 is on the premises.

In step S1020, the temporary-synchronization information presenting module 140 of the information processing apparatus 100 instructs a display device provided in the image output device 240 to display a configuration of temporary synchronization (information concerning documents that may be output outside the premises by the user 290). If the position information checking device 230 informs the user position checking module 130 in step S1018 that the position of the user 290 is on the premises, a configuration of temporary synchronization is not displayed in step S1220.

In step S1022, the image output device 240 displays a configuration of temporary synchronization for the user 290.

In step S1024, the user 290 selects a document to be printed by the image output device 240. A document to be selected is a document object subjected to temporary synchronization.

In step S1026, the image output device 240 instructs the information processing apparatus 100 to obtain the document selected in step S1024.

In step S1028, the document obtaining module 150 of the information processing apparatus 100 sends an email to the document management device 210. The email contains, for example, a device certificate of the document management device 210, account information of the user 290 used in the information processing apparatus 100, and information concerning the selected document. The format of these items of information may be the XML format, and a document including these items of information may be attached to the email.

In step S1030, the document management device 210 causes the verifying device 220 to verify the device certificate of the image output device 240 and the account information of the user 290.

In step S1032, after the verification in step S1030 has succeeded, the document management device 210 obtains a document. In this case, the document management device 210 may obtain a document stored in the document management device 210 or a document stored in another document management device within the intranet.

In step S1034, the document management device 210 uploads the document selected in step S1024 to the document obtaining module 150 of the information processing apparatus 100. When uploading the document, the document management device 210 may perform conversion processing, such as encryption of the document.

In step S1036, the document providing module 160 of the information processing apparatus 100 provides the document to the image output device 240. If the document has been subjected to conversion processing, such as encryption, the document providing module 160 performs decryption processing.

In step S1038, the image output device 240 prints the document provided in step S1036.

In step S1040, the user 290 obtains the document printed by the image output device 240.

In step S1042, the image output device 240 sends a print completion notification to the information processing apparatus 100.

In step S1044, the document deleting module 170 of the information processing apparatus 100 deletes the document (the content of the document) provided to the image output device 240. In this case, the content of information subjected to temporary synchronization is not deleted.

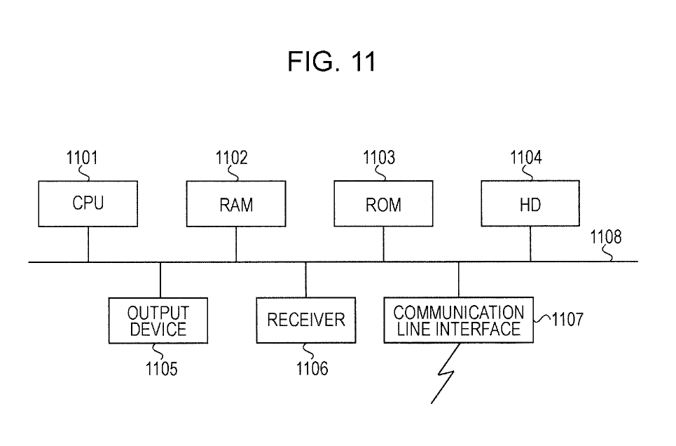

The hardware configuration of a computer that executes a program which serves as this exemplary embodiment (the information processing apparatus 100, the document management device 210, the verifying device 220, the position information checking device 230, and the image output device 240) is shown in FIG. 11. This computer is a general computer, and more specifically, a computer which serves as a personal computer (PC) or a server. The computer shown in FIG. 11 includes a CPU 1101, which serves as a processor (arithmetic unit), a RAM 1102, a read only memory (ROM) 1103, and an HD 1104, which serve as storage devices. The CPU 1101 executes a program of the temporary-synchronization processing module 110, the login processing module 120, the user position checking module 130, the temporary-synchronization information presenting module 140, the document obtaining module 150, the document providing module 160, the document deleting module 170, and so on. The RAM 1102 stores therein this program and data. The ROM 1103 stores therein a program for starting the computer. The HD 1104 is an auxiliary storage device (may be a flash memory). The computer shown in FIG. 11 also includes an output device 1105, a receiver 1106, a communication line interface 1107, and a bus 1108. The output device 1105 is, for example, a cathode ray tube (CRT) or a liquid crystal display (LCD). The receiver 1106 receives data in response to an operation performed on a keyboard, a mouse, or a touch panel by a user. The communication line interface 1107 is, for example, a network interface card, and is used for connecting the computer to a communication network. The bus 1108 connects the above-described elements and allows them to send and receive data therebetween. The above-described computer may be connected to another computer configured similarly to this computer via a network.

In the above-described exemplary embodiment, concerning an element implemented by a computer program, this computer program, which is software, is read into a system having the hardware configuration shown in FIG. 11, and the above-described exemplary embodiment is implemented in a cooperation of software and hardware resources.

The hardware configuration shown in FIG. 11 is only an example. The exemplary embodiment is not restricted to the configuration shown in FIG. 11 and may be configured in any manner as long as the modules described in the exemplary embodiment is executable. For example, some modules may be configured as dedicated hardware (for example, an application specific integrated circuit (ASIC)), or some modules may be installed in an external system and be connected to the computer via a communication line. Alternatively, a system, such as that shown in FIG. 11, may be connected to a system, such as that shown in FIG. 11, via a communication line, and may be operated in cooperation with each other. Additionally, instead of into a PC, the modules may be integrated into a home information appliance, a copying machine, a fax machine, a scanner, a printer, or a multifunction device.

In the above-described exemplary embodiment, in the example shown in FIGS. 3A and 3B, the position of a user is checked on the basis of information concerning entrance and exit to and from the premises made by the user and detected by an entrance-and-exit detector. In the example shown in FIGS. 10A and 10B, the position of a user is checked on the basis of information concerning a position detected by a position detector provided in a mobile terminal device owned by the user. However, the position of a user may be detected by using a combination of these detectors. That is, the position of a user may be detected on the basis of information concerning entrance and exit to and from the premises made by the user and detected by the entrance-and-exit detector and information concerning a position detected by the position detector. More specifically, it may be determined that the user is outside the premises on the condition that the entrance-and-exit detector has detected that the user is outside the premises and that the position information detected by the above-described position detector indicates that the user is outside the premises.

The above-described program may be stored in a recording medium and be provided. The program recorded on a recording medium may be provided via a communication medium. In this case, the above-described program may be implemented as a “non-transitory computer readable medium storing the program therein” in an exemplary embodiment of the invention.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered), a magneto-optical disk (MO), a flexible disk (FD), magnetic tape, a hard disk, a ROM, an electrically erasable programmable read only memory (EEPROM) (registered), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be part of another program, or may be recorded, together with another program, on a recording medium. The program may be divided and recorded on plural recording media. Further, the program may be recorded in any form, for example, it may be compressed or encrypted, as long as it can be reconstructed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a checking unit that checks whether or not a position of a user is outside the premises of an organization to which the user belongs;
a first obtaining unit that obtains, if it is checked by the checking unit that the position of the user is outside the premises, information that specifies documents which are stored in a document management device disposed on the premises and which are allowed to be used by the user, instead of obtaining the content of the documents;
a presenting unit that presents a list of the documents to the user;
a selector that selects a document from among the documents in the list in accordance with a selecting operation performed by the user;
a second obtaining unit that obtains the content of the document selected by the selector from the document management device disposed on the premises; and
a providing unit that provides the content of the document obtained by the second obtaining unit to an output device which outputs the content of the document.

2. The information processing apparatus according to claim 1, wherein the checking unit checks a position of the user on the basis of information concerning entrance and exit to and from the premises performed by the user and detected by an entrance-and-exit detector.

3. The information processing apparatus according to claim 1, wherein the checking unit checks a position of the user on the basis of position information detected by a position detector disposed in a mobile terminal device owned by the user.

4. The information processing apparatus according to claim 1, further comprising:
a deleting unit that deletes, upon receiving notification that a document has been output from the output device, the document from the information processing apparatus.

5. The information processing apparatus according to claim 1, wherein the second obtaining unit obtains the content of the document if at least one of or a combination of items (1) a maximum number of times the document is allowed to be output, (2) a time zone in which the document is allowed to be obtained, and (3) the position of the user satisfies a condition for obtaining the document.

6. The information processing apparatus according to claim 1, wherein the checking unit checks a position of the user on the basis of at least one of or a combination of information output from a schedule management device which manages schedules of the user and information output from an attendance management device which manages an attendance record of the user.

7. The information processing apparatus according to claim 1, wherein the checking unit checks whether or not a position of the user is outside the premises and whether or not a position of the output device is a predetermined position.

8. An information processing method comprising:
checking whether or not a position of a user is outside the premises of an organization to which the user belongs;
obtaining, if it is checked that the position of the user is outside the premises, information that specifies documents which are stored in a document management device disposed on the premises and which are allowed to be used by the user, instead of obtaining the content of the documents;
presenting a list of the documents to the user;
selecting a document from among the documents in the list in accordance with a selecting operation performed by the user;
obtaining the content of the selected document from the document management device disposed on the premises; and
providing the obtained content of the document to an output device which outputs the content of the document.

9. A non-transitory computer readable medium storing a program causing a computer to execute a process, the process comprising:
checking whether or not a position of a user is outside the premises of an organization to which the user belongs;
obtaining, if it is checked that the position of the user is outside the premises, information that specifies documents which are stored in a document management device disposed on the premises and which are allowed to be used by the user, instead of obtaining the content of the documents;
presenting a list of the documents to the user;
selecting a document from among the documents in the list in accordance with a selecting operation performed by the user;
obtaining the content of the selected document from the document management device disposed on the premises; and
providing the obtained content of the document to an output device which outputs the content of the document.
